(19) United States
(12) Patent Application Publication
(10) Pub. No.: US 2026/0134563 A1
(43) Pub. Date: May 14, 2026

(54) Fish Measurement Board with Machine-Detectable Markers and Associated System for Digital Measurement of Caught Fish

(71) Applicant: NextGen Environment Research Inc., Winnipeg (CA)

(72) Inventor: Paul Mason Cooley, Winnipeg (CA)

(21) Appl. No.: 19/236,639

(22) Filed: Jun. 12, 2025

Related U.S. Application Data
(60) Provisional application No. 63/718,536, filed on Nov. 8, 2024.

(51) Int. Cl. G06T 7/62; G06T 7/194

(52) U.S. Cl. CPC G06T 7/62; G06T 7/194; G06T 2207/30204

(57) ABSTRACT

A system for determining a length of a caught fish uses a measurement board of known size having a functional display side having machine-detectable markers. A virtual representation of the board's display side is stored in computer memory and includes virtual representations of the markers denoting their respective locations on the board. A digital image is received of a fish lain position atop the board with at least some of the markers visible. Detected markers are matched to their virtual equivalents, and the image is transformed to a coordinate system of the virtual representation of the board. A length of the fish in real world units is calculated using a combination of pixel-based image measurement of the fish and at least one dimensional characteristic of the imaged board, and at least one actual dimensional characteristic of the board stored in the virtual representation thereof.

### CROSS-REFERENCE TO RELATED APPLICATIONS

This application claims benefit under 35 U.S.C. 119(e) of U.S. Provisional Application No. 62/474,374, filed Nov. 8, 2024, the entirety of which is incorporated herein by reference.

### FIELD OF THE INVENTION

The present invention relates generally to devices and methods for measurement of caught fish by an angler, and more particularly for accurate digital measurement thereof using a smartphone or similar mobile device and a cooperative measurement board.

### BACKGROUND

Historically, angling competitions have lacked an efficient and precise means for collecting fish length and species identifications. Lack of efficiency and precision in measurement techniques means competitions often transport fish to shore-based stations for visual confirmation of size and species, sometimes taking fish far away from the habitat in which they were caught and increases the potential for mortality from long periods of retention in a water-filled live well contained in a boat. Alternatively, handheld digital photographs can be taken which contain distortion. Such photographs do not address the fact that manual measurements taken by the angler may contain error and user bias. Existing methods for measuring fish include use of a graduation-marked measurement board upon which the fish is placed, and typically features an upwardly protrusive rest or “bump” on one end at which the mouth of the fish must be aligned in abutting contact as the origin of measurement. Such boards are therefore commonly known as “bump boards”. This requires manual handling for proper orientation thereof to align the fusiform shape of the fish to the long axis of the bump board.

The idea of using modern computer and smartphone technology for angler measurement of caught fish has been proposed in prior patent literature. U.S. Patent Application US20140307086 by Yamada Electric disclosed the idea of capturing a digital photo containing a caught fish and an accompanying marker of predetermined size for determining a scale of the image relative to the real world so that the actual length of the fish can be calculated from the image. U.S. Pat. Nos. 9,928,611 and 10,275,901 by Navico Holding AS disclose similar digital measurement of fish length by image capture, using a small QR code tag for scale determination, and include alignment guidance in the photo taking process in attempt to ensure optimal framing of the fish within the captured photo. U.S. Pat. Nos. 11,357,222 and 11,733,017 by Ketch Products, Inc. disclosed mechanical design improvements to conventional “bump boards”. The Ketch patents also contemplated inclusion of a QR code on the board, for identification and registration purposes, and mentioned that the size of the QR code may be used for digital measurement purposes in a digital photo, as similarly described by Navico's earlier patents.

That said, Applicant has not seen implementation of the digital measurement concepts from the these prior patents on a commercial scale, and suspects that the proposed solutions were not robust enough to achieve accurate, reliable and consistent measurement performance given inevitable variation in the photographic quality and fish placement accuracy in the user-generated source imagery.

Applicant has developed an improved system for photo-based digital measurement of angler-caught fish that addresses those suspected shortcomings or deficiencies of the prior art.

### SUMMARY OF THE INVENTION

According to a first aspect of the invention, there is provided a system for determining a length of a caught fish using a measurement board of known size having a functional display side on which one or more sets of machine-detectable markers are embodied, said system comprising:
at least one processor;
non-transitory computer readable memory connected operably connected to said at least one processor and storing therein both:
computer executable code; and
a virtual representation of the functional display side of said measurement board, in which there are embodied virtual reference markers corresponding to, and digitally representative of, said machine-detectable markers on the functional display side of said measurement board, said virtual reference markers comprising location data digitally denoting respective locations of the machine-detectable markers on the functional display side of the measurement board;
wherein said computer executable code is configured to, when executed by said at least one processor, perform at least the following steps:
(a) receive a digital input image in which there is visually documented a subject fish in a lain position atop the functional display side of said measurement board in a position in which at least some of said machine-detectable markers are visibly unobstructed by said subject fish;
   (b) analyse said digital input image to detect said at least some of said machine-detectable markers and identify locations thereof within said digital input image, thereby denoting an identified marker set;
   (c) matching at least a subset of said identified marker set to a corresponding subset of the virtual reference markers;
   (d) performing transformation of the digital input image to a coordinate system of the virtual representation of the functional display side of said measurement board; and
   (e) calculating a length of the subject fish in real world units using a combination of:
      pixel based image measurement, in the coordinate system to which the digital input image was transformed, of both the subject fish and one or more dimensional characteristics of the measurement board documented in said digital input image; and
      one or more actual dimensional characteristics of the measurement board stored in said virtual representation of the functional display side thereof.

According to a second aspect of the invention, there is provided a fish measurement board for use in digital measurement of a length of a caught fish, said board having a functional display side atop of which said caught fish is to be laid for measurement purposes, said functional display side having a plurality of virtual reference markers thereon at distributed locations throughout at least a majority surface area of said functional display side to enable computer-vision detection, in a digital image taken of the measurement board and said fish lain thereatop, of at least a visible subset of said virtual reference markers left unobstructed by said fish lain atop the functional display side of the measurement board.

### BRIEF DESCRIPTION OF THE DRAWINGS

Preferred embodiments of the invention will now be described in conjunction with the accompanying drawings in which:

FIG. 1 schematically illustrates a measurement board and associated system of the present invention for digital measurement of a caught fish by an angler, of which the novel measurement board features an organized plurality of encoded markers (e.g. QR codes), and a more seemingly random/arbitrary splatter pattern of codeless keypoint markers, of which both types of markers are machine-detectable and purposefully usable for image processing of a digital photograph taken of the caught fish by said angler.

FIG. 1A is a flowchart illustrating an algorithmic workflow executed by the system of FIG. 1 in at least some preferred embodiments of the present invention.

FIG. 2 shows an angler-photographed digital image of a caught fish atop the measurement board, for inputting into a fish measurement algorithm of the present invention, which will perform automated correction of perspective distortion in the image prior to any measurement of fish length.

FIG. 3 schematically illustrates algorithm-executed matching of the codeless keypoint markers of the digitally imaged measurement board of FIG. 2 against counterpart virtual keypoint markers of a digitally stored virtual representation of the board.

FIG. 4 schematically illustrates algorithm-executed transformation of the digital input image using a homography matrix derived by mapping vertices of encoded markers visible in the image to known locations of corresponding vertices of the virtual markers in the virtual representation, according to one workable implementation of the perspective/distortion correction process.

FIG. 5 illustrates algorithm-executed Delaunay triangulation performed on a visible set of codeless keypoint markers in the transformed digital input image and on counterpart virtual markers in the virtual representation for similarity comparison of the resulting triangular meshes to validate an acceptability of the transformation, and to calculate or refine a pixel to real world unit conversion ratio.

FIG. 6 illustrates algorithm-executed masking and principal component analysis to measure a pixel length of the imaged fish, and derive therefrom the actual length of fish using the calculated pixel to real unit conversion ratio.

### DETAILED DESCRIPTION

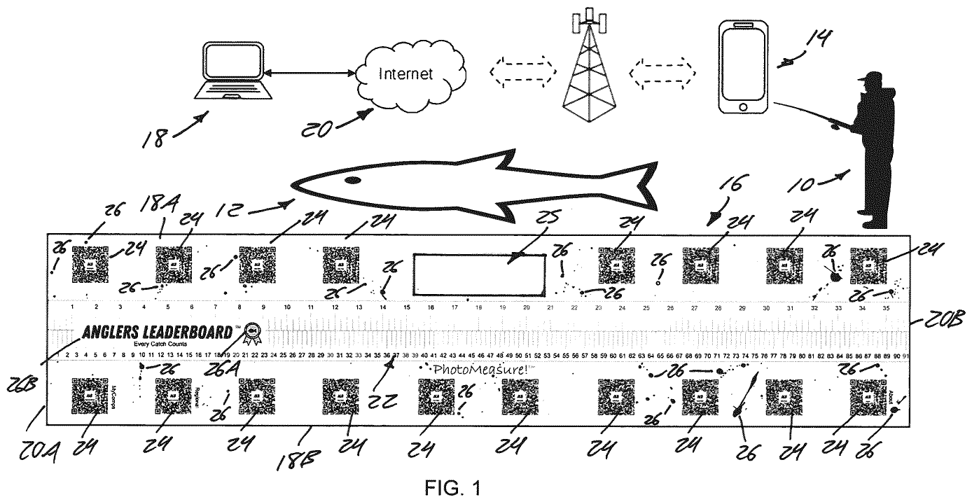

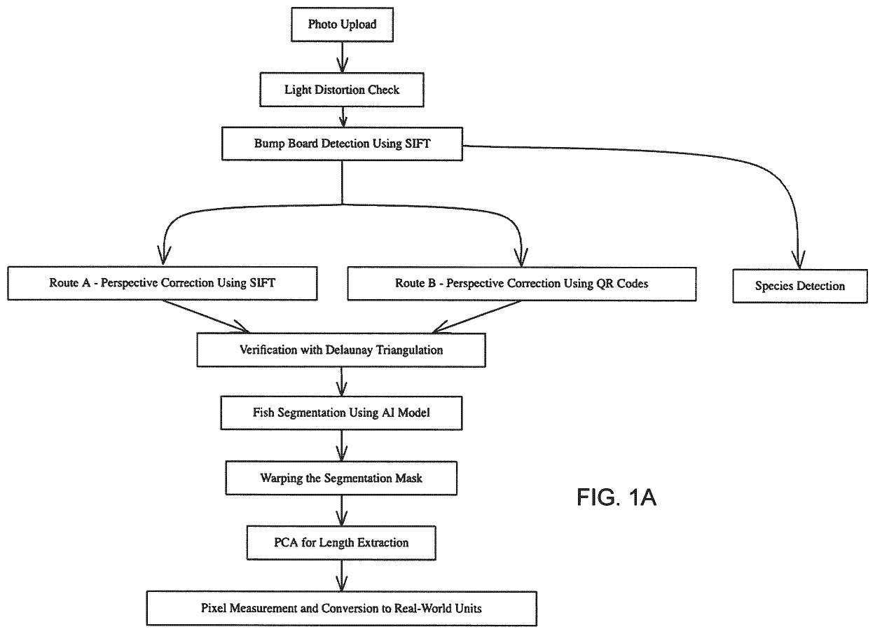

FIG. 1 schematically illustrates an overall system and operating context of preferred embodiments of the present invention, which system is exploitable by an angler 10 for the purpose of digitally measuring a caught fish 12 using, in combination, the angler's smartphone 14, or other similarly equipped mobile device capable of the various functionality ascribed herein to said smartphone, and a novel measurement board 16 used as a backdrop against which the angler 10 takes a digital photograph of the caught fish 12 using the smartphone 14. In the illustrated embodiment, the smartphone wirelessly communicates with a remote server 18 over a communications network, typically the internet 20. In this example, the smartphone runs a local software application thereon with which the angler 10 interacts via a graphical user interface of the smartphone 14 for such things as registering a user-account with the server, documenting a geographic location at which the angler is fishing for any given outing, and initiating a digital photo capture and fish measurement process whenever a fish is caught during such outing.

In the illustrated example, the digital photo of the fish 12 against the backdrop of the measurement board 16 is captured by the smartphone 14, but all subsequent processing of that image to derive a measurement of the fish 12 is performed by the server 18, to which the smartphone 14 transmits the digital photo, along with supplementary data in accompaniment thereto, for example to enable logging of this catch, the geographic location thereof and the size of the fish once determined from the processing of the digital photo in the manner described herein, all of which logged data is stored in association with a user account registered by, or for, this particular angler 10. In other embodiments, the particular distribution of computer executed steps, tasks, processes, etc. described herein between the smartphone 14 and the remote server 18 may vary, though server executed image processing approach described of the preferred embodiment below is thought to denote the most practical and typical implementation given the current state of technology and practice.

The measurement board 16 itself is novel over known bump boards of the prior art, and in the illustrated embodiment is embodied entirely by a singular flat board of rectangular shape having two long lengthwise sides 18A, 18B and two shorter widthwise sides 20A, 20B denoting opposite ends of the board. The length of the board is notably greater than the width thereof, with the intention that the body of the fish 12 is laid lengthwise of the board 12 when placed thereon, in similar fashion to use of a conventional bump board, though the illustrated measurement board 16 lacks the typical “bump” of upwardly protruding character from the flat board that, in a conventional bump board, would form only the base part of the bump board. The drawings show a topside of the measurement board 16, referring to the side thereof atop which the fish 12 is placed during use of the measurement board 16 and which topside thereof serves as a functional display side of the board 16 at which machine-detectible markers are embodied so as to appear in the digital photograph of the fish 12 to enable purposeful exploitation of these machine-detectable markers in the imaging processing steps performed by the server 18 to ultimately determine the length of the fish 12 documented in the capture digital photograph.

The illustrated example of the measurement board 16 includes a ruler-like human-readable measurement guide 22 running lengthwise of the board 16 at the functional display side thereof in centered relation between the two lengthwise sides 18A, 18B board, which measurement guide has measurement graduations marked thereon at regular lengthwise intervals therealong. That said, the digital fish measurement capability of the present invention is in no way reliant or dependent on such inclusion of a human-readable measurement guide 22, which therefore may be omitted entirely, though some anglers 10 may like to have this more conventional inclusion of a humand-readable measurement guide thereon to visually gauge the size of the caught fish for themselves, independently of the digital measurement performed by the system of the present invention. Such preference may prove particularly useful in instances of communication network outages, during which the digital photograph of the fish cannot be successfully communicated to the server to derive the digital measurement of the fish and communicate the results of said digital measurement back to the angler's smartphone 14 for immediate consumption and gratification.

The machine-detectable markers on the functional display side of the board 16 include a plurality of encoded markers 24 that are distributed at spaced intervals from one another over the surface area of the board's functional display side, and in the illustrated example, are more specifically arranged in two linear rows of such encoded markers 24, of which each row runs along a respective one of the board's two lengthwise sides 18A, 18B at a short distance inward therefrom. In the illustrated example, a bottom one of these two rows has a greater quantity of encoded markers 24 therein than the top one of the two rows, owing to interruption of the top row by a handle opening 25 that penetrates through the board nearest the top lengthwise edge 18A thereof to form a carrying handle for the board 16. In other instances, the two rows may have an equal quantity of encoded markers 24 therein, for example made possible by alternative placement of the handle opening, or integration of a different style of carrying handle.

The encoded markers 24 are referred to as such because each has encoded therein a machine-readable code that is machine-readable by the image processing fish-measurement algorithm to which the captured digital photograph is inputted for processing to ultimately derive the length of the photographed fish 12. In the illustrated example, each encoded marker 24 is embodied as a Quick-Response code (QR code), though other code-embodying marker types 24 readable by a machine may alternatively be employed to similar purpose. Each of the encoded markers 24 embodies a different readable code therein, whereby each encoded marker 24 is uniquely identifiable by the algorithm in distinguished identification from each of the other encoded markers 24.

The illustrated embodiment also includes a plurality of codeless keypoint markers 26, which lack any computer readable code embodied thereon, but are likewise optically visible so as to each visually appear in any digital photography taken of the functional display side of the measurement board 16, provided that the given marker is not visually obstructed beneath the fish 12 lain atop the measurement board 16. In the instance of such optical visibility in the digital photograph, each such codeless keypoint marker 26 is accordingly machine-detectable by the fish-measurement algorithm during image processing steps thereof. As outlined above, the encoded markers 24 are laid out in a rather structured or systematic layout or array, particularly in two straight and lengthwise rows in the illustrated example, of which one row is optionally a split-row interrupted by the handle opening 26, and the other is an unsplit full row spanning more uniformly across the length of the board, In contrast, the codeless keypoint markers 26 are arranged in a less organized or systematic and more randomly/arbitrarily distributed fashion, with the vast majority, if not all, of the codeless keypoint markers 26 being irregularly shaped markings of splatter-drop appearance at more randomly/arbitrarily spaced locations imparting a splatter-patterned appearance to the measurement board 16. The randomness, semi-randomness, irregularity, semi-irregularity or non-uniformity of the layout of codeless keypoint markers 26 is found to provide highly dependable performance in use of these codeless keypoint markers for the image processing steps defined here, and their inclusion is believed superior to exclusive use of markers of lesser quantity and more uniform distribution over the surface area of the board 16.

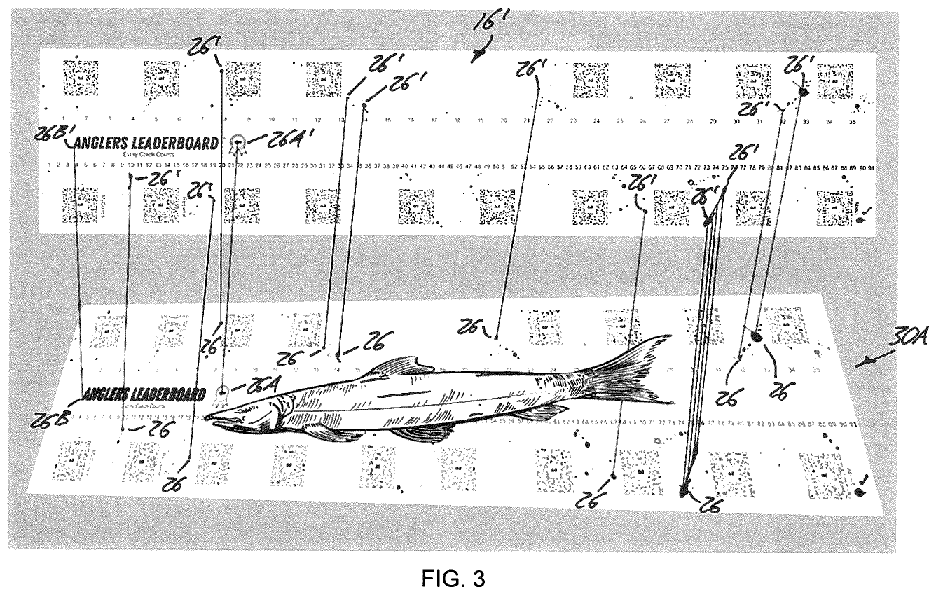

As illustrated, the codeless keypoint markers 26 are grouped in clusters of greater density than the systematically arranged encoded markers 24 of overall lesser quantity than the codeless keypoint markers. The combination of systematic and semi-irregular marker layouts has proven a robust solution, whereas a systematic marker layout alone can create confusion in machine learning analysis of the board, where, using human vision as an analogy, the machine “loses its place” on the board, which can create error distortion that cannot be fixed. Preferably the codeless keypoint markers 26 includes markers of different colour from one another, for example at least two or three different colours of codeless keypoint markers 26, the latter of which Applicant has employed with good results, believed to be attributable, at least in part, to an intensity difference among the codeless keypoint markers when performing a Scale-Invariant Feature Transform (SIFT) computer-vision technique, described further below for feature detection in at least some preferred embodiments of the invention. Not all of the codeless keypoint markers 26 need be embodied in the splatter pattern, as demonstrated in the illustrated example by embodiment of one codeless keypoint marker 26A by an icon or logo, such as the trophy ribbon icon seen in the drawings next to the branded name (Anglers Leaderboard, optionally abbreviated as ALB) of the measurement board 16, part of which printed brand name may serve as another codeless keypoint marker 26B, as shown of the letter “A” of “Anglers” in FIG. 3.

In non-transitory computer readable memory of the server 18, which denotes the machine(s) responsible in this embodiment for processing the digital photographs captured by the smartphone 14, there is stored the computer executable code for automated execution of the various algorithm steps and processes described herein by one or more processors connected to such computer readable memory, and is also digitally stored a virtual representation of the functional display side of the measurement board (also referred to herein as a virtual board representation, for short), which embodies virtual reference markers each corresponding to a respective one of the encoded and codeless markers 24, 26 of the actual measurement board 16. For each encoded and codeless marker 24, 26, the virtual board representation includes stores location data representative of a respective location on the actual measurement board 16 at which that particular marker 24, 26 resides within a 2D coordinate system of the functional display side thereof, in which coordinate system the four perimeter sides 18A, 18B, 20A, 20B are also defined in a manner likewise stored in memory, whereby the virtual board representation embodies a digital map of at least the four outer boundaries of the rectangular functional display side of the board 16 and the whereabouts of all the machine-detectable markers 24, 26 located within those boundaries. This virtual representation of the measurement board 16 is useful in the presently disclosed invention for numerous purposes, including identification of the measurement board 16 within the digital photograph of the measurement board 16 and caught fish 12, perspective distortion correction of the imaged measurement board 16 in the digital photograph, and accurately scaled conversion from pixel-based fish length measurement within the processed digital photograph to real world measurement units.

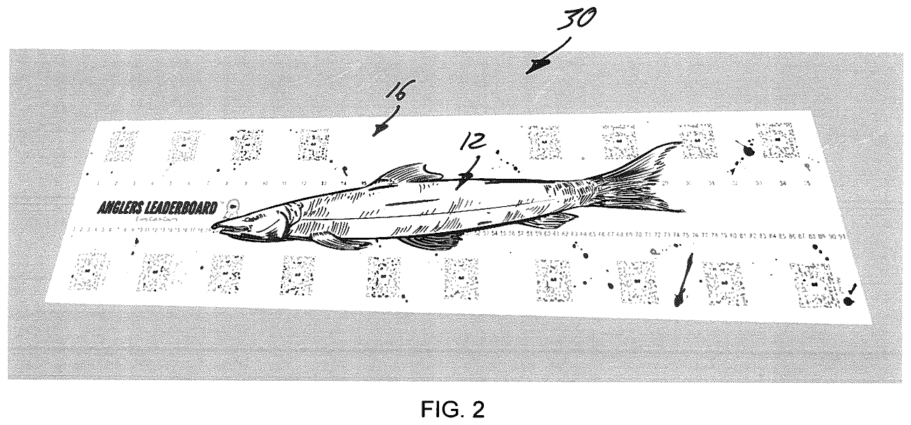

Turning now to the algorithmic workflow executed in operation of the present invention, an overview of which is presented in FIG. 1A, a digital photograph taken by the angler 10, with the smartphone 14, of the caught fish 12 in a position laid atop the functional display side of the measurement board 16 in a position running generally lengthwise thereof, is uploaded by the smartphone 14 to the server 18, whether such upload be triggered in automated fashion by the local software application of the smart phone 14 upon capture of the digital photograph, or whether such uploaded be triggered only after prompted approval of the digital photograph for upload by the angler 10. Such initially captured and uploaded photograph is shown in FIG. 2, and is referred to herein as the digital input image 30, being that this FIG. 2 photograph denotes a raw (as yet unprocessed) input to the novel fish measurement algorithm that is then executed, in automated fashion, by the server 18. The FIG. 2 example illustrates how the functional display side of the imaged measurement board documented in the digital input image will typically deviate, at least somewhat, from an ideally parallel relationship to the 2D coordinate plane of the image and may, perhaps frequently, be of notably distorted perspective relative to that plane, substantial correction of which be made by the algorithmic workflow described below of the preferred embodiments of the present invention.

Any algorithmic steps, processes, workflow etc. described herein, unless explicitly described as executed by human intervention by the angler or other human user or operator, is executed in automated fashion by the one or more processors of the server 18, whether that server be embodied in one or more machines, or by one or more processors of the smartphone 14 or other mobile device, depending on distribution of such tasks among one, the other or both the server 18 and the smartphone or other mobile device, which distribution may vary, as mentioned above.

After upload the image, and referring again to FIG. 1A, the algorithm may check for light distortion in the digital input image, in which the image is scanned for light inconsistencies and applies corrective techniques to cure or mitigate any uneven lighting or shadow effects, for example by applying such corrective techniques as histogram equalization or adaptive illumination correction. The corrections better ensure uniform brightness across the image, allowing imaged markers 24, 26 and other visible features of the imaged measurement board 16 to be detected without interference from shadows or bright spots. Standardizing the light distribution enhances the accuracy of later matching of imaged and virtual markers, and the precision of later masked-segmentation of image content.

Next, after preferred inclusion of such lighting correction, the algorithm attempts identification of visible markers on the functional display side of the imaged measurement board 16 in the light-corrected digital input image 30A, meaning markers that are not visually obstructed from such identification by the presence of the imaged fish 12 atop the imaged measurement board 16. In the present embodiment, with both encoded and codeless markers 24, 26, the codeless keypoint markers 26 may be used for such purpose, in this case by executing a SIFT algorithm to detect and match the imaged and visible codeless keypoint markers 26 on the imaged measurement board 16 in the light-corrected digital input image 30A with the corresponding virtual markers in the virtual board representation. Such matching of the imaged and virtual codeless keypoint markers is schematically represented in FIG. 3, where the light-corrected digital input image 30A and its imaged visible codeless keypoint markers 26 are shown below a schematic representation of the virtual board representation 16′ and its corresponding virtual keypoint markers 26′, 26A′, 26B′. The SIFT algorithm extracts from the imaged measurement board 16 the visible subset of codeless keypoint markers 26, which are invariant to scaling, rotation, and slight viewpoint changes. The imaged and virtual codeless keypoint markers are matched using a nearest-neighbor algorithm to establish correspondences between the digital input image and the virtual board representation.

After the bump board is identified by positive matching of such imaged and virtual codeless keypoint markers, the stored location data concerning those markers and the stored boundaries of the measurement board are preferably used to map the boundaries of the imaged measurement board 16 in the light-corrected digital input image, which are used as, or to help define, boundaries between the imaged measurement board 16, on which the imaged fish 12 resides, and background image content, the latter of which is then removed, thus isolating the imaged measurement board 16 and fish 12 for further processing. While background removal is not strictly necessary to the fish measurement goal of the overall algorithm, background removal enhances later image segmentation quality by filtering out any unwanted noise outside the segmentation mask during fish detection. While the encoded markers 24 and the stored location data of their virtual counterparts could similarly be employed for the purposes of board identification, boundary location and background removal instead of using the codeless keypoint markers 26, use of the codeless keypoint markers has proven to be more robust for reliable detection and accurate boundary definition.

Next in the workflow of FIG. 1A, while also not essential to the fish measurement purpose set forth herein, another optional but preferable inclusion in the algorithmic workflow is species detection of the imaged fish in the preferably light-corrected and now preferably isolated image of the measurement board 16 and accompanying fish 12. For such purpose, the isolated image is inputted to a trained artificial intelligence model that has been trained on a large volume of imaged fish of known species in order to classify the imaged fish 12 by species, for example using an EfficientNetV2 model trained in such fashion. The preceding and preferably included background removal step improves classification accuracy by removing extraneous background imagery potentially detrimental to the species classification results. Providing both fish length measurement and species identification creates a comprehensive data output from the algorithm, results of which are preferably both logged by the server 18, and also communicated back to the smartphone 14 or other mobile device of the angler 10 for instantaneous, or at least prompt display, to the angler 10 at their present fishing site for immediate confirmation and gratification.

Next in the preferred workflow implementation of FIG. 1A is automated correction of perspective distortion of the preferably light corrected and background isolated digital input image. For the present embodiment that features both encoded markers 24 and codeless keypoint markers 26, two different options for such perspective correction are contemplated, either of which may be used in any given instance, given inclusion of both marker types on the measurement board of this embodiment, though in other embodiments with only one marker type or the other, the type of marker will dictate which the two perspective correction approaches at the fourth stage of FIG. 1A will be performed, where the flowchart is bifurcated into Route A and Route B.

Attention is first given to Route A, in which case it is the codeless keypoint markers 26 that are exploited for this purpose of perspective distortion correction, which can make use of the previously performed matching of detected visible codeless keypoint markers 26 in the digital input image to the corresponding virtual codeless keypoint markers of the virtual board representation using the SIFT approach. Here, a homography transformation matrix for transforming pixels from the plane of the functional display side of the imaged measurement board 12 in the preferably now light corrected and background isolated digital input image to the 2D coordinate system of the virtual board representation is calculated using the coordinate points of the visibly imaged and detected codeless keypoint markers 26 in the image and the stored location data of the corresponding virtual codeless keypoint markers 26′ in the virtual board representation. This calculated homography matrix H is then usable on the isolated image of the measurement board to transform the coordinate points of its pixels into alignment with the coordinate system of the virtual board representation, thus warping the image. Mathematically, p′=H·p, where p is a coordinate point in the pre-transformation digital input image and p′ is the transformed coordinate point in the coordinate system of the virtual board representation.

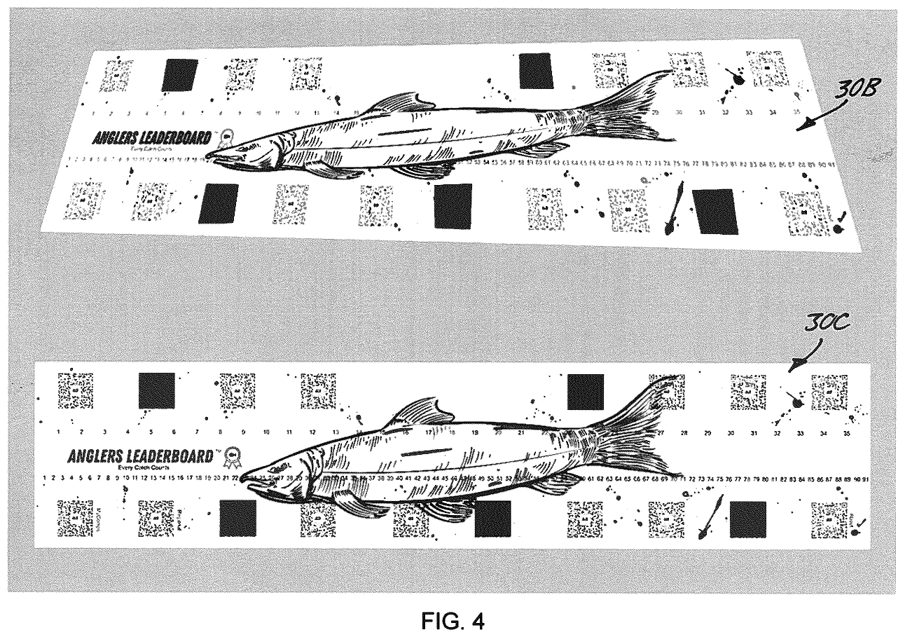

The Route B alternative for derivation of the homography matrix H instead uses the encoded markers 24 of the imaged measurement board 16 and their virtual equivalents digitally stored as part of the virtual board representation, in a manner schematically illustrated in FIG. 4. The encoded markers 24 of the illustrated example of the measurement board 16 are QR codes, and thus have polygonal, and more specifically square, outer perimeters characterized by a plurality, and more specifically four, outer vertices. The location data of the corresponding virtual markers of the virtual board representation includes either the coordinate points of the four vertices of the corresponding virtual marker in the coordinate system of the virtual board representation, or if not the coordinate points of those four vertices, sufficient location data from which those four coordinate points are derivable (e.g. one specific corner or a center point of the square, and the width/height of the square). The homography matrix H is calculated using the coordinate points of the outer vertices of the visibly imaged, detected and matched encoded markers 24 in the image and the stored location data of the corresponding virtual encoded markers 24′ in the virtual board representation. The homography matrix H is then applied to the isolated image of the measurement board to transform the coordinate points thereof to align with the coordinate system of the virtual board representation, thus warping the image as likewise described for the alternative Route A implementation of this perspective correction stage.

It will be appreciated that this method of using vertices of polygonal markers to calculate the homography matrix H is not necessarily dependent on those polygonal markers specifically being QR codes or other encoded markers, and may similarly be performed using codeless markers, provided that they can somehow be sufficiently identified in distinction from one another and properly matched to their virtual counterparts of the virtual board representation. That said, the use of encoded markers for such polygonal vertex derivation of the homography marix is an elegant solution, where the encoded markers can all be characterized by the same polygonal shape yet be easily identifiable in distinguishable fashion from one another, via machine reading of their respectively embedded codes, to be able to look up the location data of the corresponding virtual markers of the virtual board representation to enable the vertex mapping between the two coordinate planes. FIG. 4 shows the imaged measurement board and fish 12 of the light-corrected background removed image 30B in the top of the figure, where it can be seen that the real world square shapes of the encoded markers 24 are distorted in the untransformed (unwarped) image, and the bottom of the figure shows the post-transformation (warped) image 30C after application of the calculated homography matrix, where the matched encoded markers (overlaid in black for distinction) of the image have been transformed to truer representation of their real-world square shape as part of the transformation (warping) of the entire image to the coordinate system of the virtual board representation, which will enable subsequent measurement of the fish size at accurate scale.

Regardless of whether the homography transformation was performed in accordance with Route A or Route B, a pixel to real world unit conversion ratio, for later use at the fish measurement stage, is now calculable using pixel-based measurement of one or more dimensional characteristics of the imaged measurement board in the transformed (warped) image, and a known real world measurement of a corresponding one or more dimensional characteristics of the actual measurement board, which real world dimensions of said one or more dimensional characteristics of the actual measurement board are stored in computer memory as part of the virtual board representation. In preferred embodiments, the one or more dimensional characteristics of the imaged measurement board may be the size of the identified and matched encoded markers 24 of the imaged measurement board in the post-transformation image, and/or the distance between pairs of the identified and matched encoded markers 24 of the imaged measurement board. Each such dimensional characteristic of the imaged measurement board has a stored or calculable counterpart that is stored in, or derivable from, marker-related data stored in computer readable memory as part of the virtual board representation. In typical embodiments, the encoded markers 24 are all the same size, and that size is stored in memory, together with the aforementioned location data denoting the whereabouts of each encoded marker 24 on the actual measurement board 16, from which the distance between any pair of the encoded markers can be calculated. Use of the size of multiple encoded markers 24, and/or use of distances between pairs of such encoded markers 24, enables more precise determination of an accurate pixel to real world unit ratio, in contrast and improvement to the prior art use of a singular QR code or other singular marker of known size to derive such ratio.

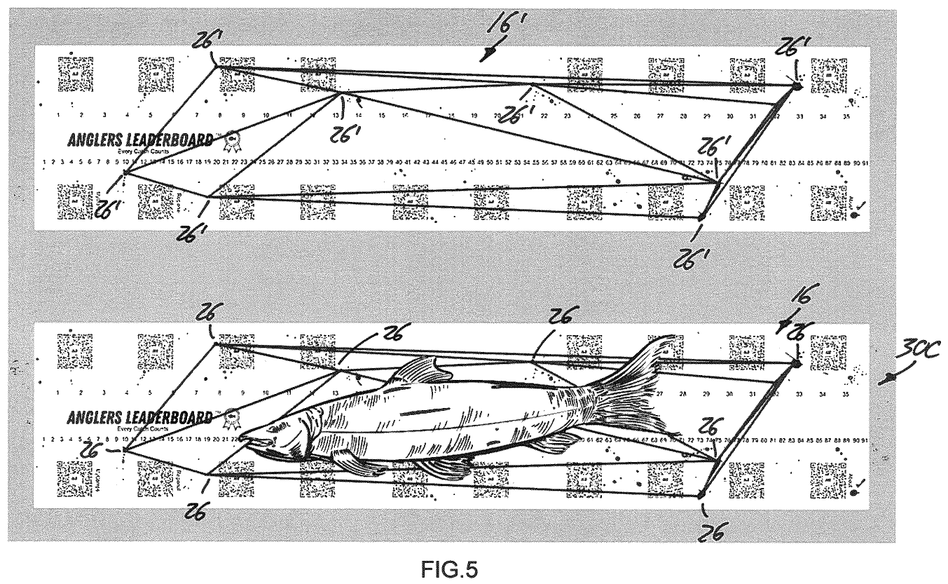

Next, at the fifth stage of the workflow shown in FIG. 1A, the preferred implementation of the algorithm includes a verification of the performed transformation (warping) to confirm that it fulfills an acceptability threshold, rather than to proceed onward to subsequent stages of the workflow on a potentially unsafe presumption that the transformed image is an acceptably accurate recreation of the imaged measurement board in the coordinate system of the virtual board representation. FIG. 5 schematically illustrates a preferred implementation of this verification process, though other verification techniques may alternatively be employed. In the preferred implementation, Delaunay tessellation/triangulation is performed on centroids of the codeless keypoint markers 26 that were successfully identified in the image and matched to their virtual marker counterparts in the preceding stages of the algorithm, and is also likewise performed on the centroids of those virtual marker counterparts in the virtual board representation.

The triangulation process constructs triangles between the codeless keypoint markers such that no point lies inside the circumcircle of any triangle, maximizing the minimum angle of each triangle and ensuring a non-degenerate mesh. The technique is usable to confirm that the spacing and angles between transformed keypoint markers in the warped image are consistent with the spacing an angles between the corresponding virtual keypoint markers in the virtual board representation. The proportions of the triangles in the triangular mesh generated from the codeless keypoint markers 26 of the warped image are compared against the proportions of the triangles in the triangular mesh generated from the corresponding virtual keypoint markers 26′ of the virtual board representation, which denote the ground truth that the performed transformation was intended to achieve or best approximate. If the proportions are deemed sufficiently consistent, e.g. within a predetermined threshold, then the transformation is deemed valid.

The comparative triangulations performed for transformation validation purposes within this stage also enable optional recalculation or refinement of the pixel to real world unit conversion ratio, which as describe may have been previously derived from the encoded markers 24. Here, the ratio is derived by, or adjusted based on, comparison of the scale of the triangles of the triangular mesh generated from the transformed (warped) image to the scale of the triangles of the triangular mesh generated from the virtual board representation. In some embodiments, this triangulation based calculation of the pixel to real world unit conversion ratio may be used instead of the earlier described use of the size and/or spacing of the imaged encoded markers 24 as the sole calculation of the pixel to real world unit conversion ratio, for example in embodiments optionally omitting the image encoded markers 24 altogether in favour of exclusively codeless keypoint markers.

Turning to the sixth stage of the FIG. 1A workflow, here the fish 12 is segmented from the image using an artificial intelligence model trained for such purpose, for example a SWIN V1 Mask RCNN model trained on images of various fish photographed on the measurement board to identify pixels belonging to the imaged fish, in distinction from any part of the imaged measurement board, or any image artifacts, in the isolated image of the fish and measurement board. In at least some embodiments, such binary masked segmentation of the fish 12 from the isolated image may be performed on the pre-transformation (unwarped) image, particularly if the model is being trained on digital photographs uploaded to the system by users, whose digital photographs would embody a variety of differently framed photographs of varying perspective and quality, and that have not been subject to perspective distortion correction. Using raw inputted photographs before any processing thereof can also save on system resources, by rejecting particularly poor or fishless photographs before any processing steps are performed thereon. In embodiments where the binary mask segmentation is performed on the pre-transformation input image, the mask-segmented image is subsequently transformed (warped) using the previously derived homography matrix already used for perspective distortion correction of the imaged measurement board.

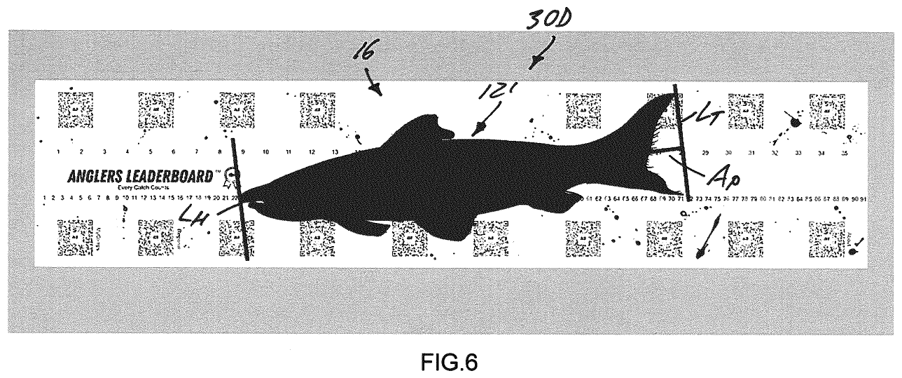

FIG. 6 schematically denotes the post-transformation (warped) mask-segmented image 30D, where all pixels previously embodying the imaged fish 12 are blacked out, which pixels thus all share a same one of two possible binary values after application of the binary mask. While the drawing shows presence of the imaged measurement board 16 for contextual purposes, in the actual binary masked image, all other pixels outside the mask-segmented fish 12′ would share the other one of the two binary values, so that each pixel in the mask-segmented post-transformation image 30D has one of two possible values (black or white).

Next, at the second last stage of the FIG. 1A workflow, principle component analysis (PCA) is performed on the mask-segmented fish 12′ to identify the principal axis of variation, which, generally, is safely assumed to be the fish's head-to-tail length, which measurement is the target interest of the fish measurement algorithm. The principle axis A_{P} derived at this step therefore denotes a measurement line along which the length of the mask-segmented fish 12′ is measurable, in pixels, which once derived is subsequently convertible to real world units using the previously derived pixel to real world unit conversion ratio. FIG. 6 shows the principle axis A_{P} in truncated form, capped by a head and tail reference lines L_{H} and L_{T} which are illustrated here for schematic purpose to denote opposing lengthwise extremities of the mask-segmented fish 12′ along the principle axis A_{P}. In practice however, the PCA analysis generates the principle axis A_{P} with indefinite length that does not auto-terminate at these two lengthwise extremities of the mask-segmented fish 12′.

Therefore, in order to enable pixel-based measurement of length of the mask-segmented fish 12′ along the generated principle axis A_{P}, a final pixel measurement stage is included in the workflow of FIG. 1A. This stage involves projection of all masked pixels of the mask-segmented fish 12′ onto the principle axis A_{P} on projection lines perpendicular thereto. The result of such projection is that the sole remaining pixels of binary masked value assigned to the mask-segmented fish 12′ now all reside on the principle axis A_{P}, whereupon the pixel-based length measurement of the mask-segmented fish 12′ is derivable by performing a pixel count of all pixels of that binary masked value that reside on the principle axis A_{P}.

Having successfully measured the length of the imaged fish in pixels, the final length calculation step in the algorithmic workflow of FIG. 1A is calculation of the real world length of the actual fish by multiplying the measured pixel length of the fish by the pixel to real world unit conversion ratio that was derived earlier. The calculated real world length of the fish (e.g. in centimeters, inches or other suitable length units), is logged in a database of the server 18, in associated relationship to a registered user account of the angler 10, to the location at which the fish was caught (as communicated to the server previously from the angler's smartphone 14), and to the identified species of the fish, if identified at the species detection stage of the FIG. 1A workflow in embodiments including such functionality. The calculated real world length of the caught fish 12, and the species thereof if likewise determined as part of this resultant data set output from the fish measurement algorithm, are preferably communicated back to the user's smartphone 14 in real time, but is also retrievable at any subsequent time by the local software application on the smartphone, via communication thereof with the server 18 to pull such resultant data from historical logs of the angler's catches, which historical catch record is accumulated in the database over time.

In summary, preferred embodiments of the invention improve notably over the prior art by removing perspective distortion from photographs taken of the fish on the measurement board. Unlike a conventional bump board, the fish can lie in either a left or right facing orientation at varying degrees of angular agreement or disagreement with a lengthwise axis of the board, which decreases handling issues involved in the precise fish placement requirements of the prior art and can also reduce necessary time out of the water for measurement purposes. User length bias in placement of the fish and framing of the photograph is removed by correction of perspective distortion and full automation of the length calculation.

Automated length calculation using one or both sets of two types of computer-detectible markers affords scale-independent precision of measurement for small to large fish. The encoded markers 24 arranged in systematically spaced rows along the perimeter of the measurement board better support measurement of larger fish. The more dense and semi-irregular network of codeless keypoints markers subjected to tessellation is better suited to fishes at the extremes of size. When the automated distortion removal and length calculation is coupled with machine learning of fish species identification, identified species of caught fish can be documented and shared rapidly. Access to the invention by anglers at large enables common use of a singular standardized form of measurement, promoting fair game play. The invention also helps the fish to be released quickly back into the habitat in which it was caught, suggesting the invention may help improve fish survival and better maintain fish population health.

Since various modifications can be made in the invention as herein above described, and many apparently widely different embodiments of same made, it is intended that all matter contained in the accompanying specification shall be interpreted as illustrative only and not in a limiting sense.

1. A system for determining a length of a caught fish using a measurement board of known size having a functional display side on which one or more sets of machine-detectable markers are embodied, said system comprising:
at least one processor;
computer readable memory connected operably connected to said at least one processor and storing therein both:
computer executable code; and
a virtual representation of the functional display side of said measurement board, in which there are embodied virtual reference markers corresponding to, and digitally representative of, said machine-detectable markers on the functional display side of said measurement board, said virtual reference markers comprising location data digitally denoting respective locations of the machine-detectable markers on the functional display side of the measurement board;
wherein said computer executable code is configured to, when executed by said at least one processor, perform at least the following steps:
(a) receive a digital input image in which there is visually documented a subject fish in a lain position atop the functional display side of said measurement in a position in which at least some of said machine-detectable markers are visibly unobstructed by said subject fish;
(b) analyse said digital input image to detect said at least some of said machine-detectable markers and identify locations thereof within said digital input image, thereby denoting an identified marker set;
(c) matching at least a subset of said identified marker set to a corresponding subset of the virtual reference markers;
(d) performing transformation of the digital input image to a coordinate system of the virtual representation of the functional display side of said measurement board; and
(e) calculating a length of the subject fish in real world units using a combination of:
pixel based image measurement, in the transformed digital input image, of both the fish and one or more dimensional characteristics of the measurement board documented in said transformed digital input image; and
one or more actual dimensional characteristics of the measurement board stored in said virtual representation of the functional display side thereof.

2. The system of claim 1 wherein at least a subset of said machine-detectable markers are encoded markers each embodying a machine-readable code therein.

3. The system of claim 2 wherein said each of said encoded markers embodies therein a different respective machine-readable code.

4. The system of 3 wherein the different respective machine-readable code of each encoded marker embodies therein a respective marker identifier by which that marker is identifiable for matching purposes in step (c).

5. The system of claim 2 wherein said encoded markers are QR codes.

6. The system of claim 1 wherein the subset of identified markers include polygonal markers each having plurality of vertices, and step (d) comprises calculating a transformation matrix based on mapping of detected vertices of the polygonal markers in the digital input image to known vertex coordinates of corresponding virtual polygonal markers in the coordinate system of the virtual representation of the functional display side of said measurement board.

7. The system of claim 2 wherein the encoded markers have polygonal outer perimeters with a plurality of outer vertices, the subset of identified markers comprise some of said encoded markers, and step (d) comprises calculating a transformation matrix based on mapping of detected outer vertices of the subset of identified markers to known vertex coordinates of the corresponding subset of the virtual reference markers in the coordinate system of the virtual representation of the functional display side of said measurement board.

8. The system of claim 1 wherein at least a subset of the machine-detectable markers are codeless keypoint markers void of any machine-readable code therein.

9. The system of claim 8 wherein a layout of said codeless keypoint markers is an irregular pattern lacking uniformity in size, shape and marker-to-marker spacing among said codeless keypoint markers.

10. The system of claim 9 wherein said codeless keypoint markers are laid out in a visually splatter-like pattern.

11. The system of claim 8 wherein said codeless keypoint markers include thereamong codeless keypoint markers of different colour from one another.

12. The system of claim 8 wherein said computer executable code is further configured to execute an intervening transformation validation step between steps (d) and (e).

13. The system of claim 12 wherein said intervening transformation validation step, using post-transformation coordinate points of detected codeless keypoint markers detected, matched and transformed in steps (b), (c) and (d) and the location data of associated virtual markers matched to said detected uncoded markers in step (c), generates respective meshes among the post-transformation coordinate points and the associated virtual markers, and compares characteristics of said respective meshes to evaluate an acceptability of the transformation.

14. The system of claim 13 wherein said intervening transformation validation step comprises calculating or updating a pixel to real world unit conversion ratio, for use in step (e), based on scale comparison of said respective meshes.

15. The system of claim 8 wherein detection and matching of the codeless keypoint markers in steps (b) and (c) is used in step (c) to confirm presence of the measurement board in the digital input image.

16. The system of claim 1 wherein detection and matching of the machine-detectable markers in steps (b) and (c) is used, in a background removal step executed thereafter, in combination with the location data to locate and map boundaries of the measurement board documented in the digital input image, and execute a background removal process to remove background image content outside said boundaries, thereby generating an isolated image of the measurement board and the fish lain thereatop.

17. The system of claim 16 wherein the executed steps include, after said background removal step, a species determination step that comprises inputting the isolated image to a trained specifies classification model trained on various fish species, and receiving back a resultant species identification of the fish.

18. The system of claim 1 wherein the one or more dimensional characteristics comprise at least one of:
one or more size dimensions of one or more of the machine-detectable markers; and/or
one or more marker-to-marker distances each measured from one or more of the machine-detectable markers to another.

19. The system of claim 1 in combination with said measurement board.

20. A computer-implemented method comprising automated execution of, by one or more processors, via execution thereby of executable statements and instructions stored in computer readable memory coupled to said one or more processors, at least steps (a) through (e) of claim 1.

21. Non-transitory computer readable memory have stored therein executable statements and instructions for execution by one or more processors to, when executed, perform, at least, steps (a) through (e) of claim 1.

22. A fish measurement board for use in digital measurement of a length of a caught fish, said board having a functional display side atop of which said caught fish is to be laid for measurement purposes, said functional display side having a plurality of machine-detectable markers thereon at distributed locations throughout at least a majority surface area of said functional display side to enable computer-vision detection, in a digital image taken of the measurement board and said fish lain thereatop, of at least a visible subset of said machine-detectable markers left unobstructed by said fish lain atop the functional display side of the measurement board.

23. The fish measurement board of claim 22 wherein said machine-detectable markers comprise a plurality of encoded markers each embodying a machine-readable code therein.

24. The fish measurement board any one of claim 22 wherein said machine-detectable markers comprise codeless keypoint markers.

25. The fish measurement board of claim 22 wherein said machine-detectable markers comprise both a plurality of encoded markers each embodying a machine-readable code therein, and a plurality of codeless keypoint markers
